(19) United States
(12) Patent Application Publication
(10) Pub. No.: US 2025/0212181 A1
(43) Pub. Date: Jun. 26, 2025

(54) USER EQUIPMENT AND RESOURCE SELECTION METHOD FOR BACK-TO-BACK TRANSMISSIONS IN SIDELINK COMMUNICATION, AND CHIP

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/079,419

(22) Filed: Mar. 13, 2025

Related U.S. Application Data
(63) Continuation of application No. PCT/CN2022/130082, filed on Nov. 4, 2022.

(51) Int. Cl. H04W 72/02; H04B 17/318; H04L 1/1812; H04W 72/0446; H04W 72/25; H04W 72/566; H04W 92/18

(52) U.S. Cl. CPC H04W 72/02; H04B 17/328; H04L 1/1812; H04W 72/0446; H04W 72/25; H04W 72/566; H04W 92/18

(57) ABSTRACT

A resource selection method for back-to-back transmissions in sidelink communication (SL) by a user equipment (UE) includes triggering, by a higher layer of the UE, a first layer of the UE to perform a resource selection procedure based on one or more of parameters provided by the higher layer to report a remaining set of candidate resources, wherein the remaining set of candidate resources includes at least one set of resources in contiguous time slots.

### CROSS-REFERENCE TO RELATED APPLICATION

This application is a continuation of International Application No. PCT/CN2022/130082, filed Nov. 4, 2022, the entire disclosure of which is incorporated herein by reference.

### BACKGROUND OF DISCLOSURE

### 1. Field of the Disclosure

The present disclosure relates to the field of communication systems, and more particularly, to a user equipment (UE) and a resource selection method for back-to-back transmissions in sidelink communication (SL), which can provide a good communication performance and/or provide high reliability.

### 2. Description of the Related Art

In the advancement of radio wireless transmission and reception directly between two devices, which is often known as device-to-device (D2D) communication, it was first developed by 3rd generation partnership project (3GPP) and introduced in release 12 (officially specified as sidelink communication) for public safety emergency usage such as mission critical communication to support mainly low data rate and voice type of connection. In 3GPP releases 14, 15, and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in release 17 in the area of power saving and transceiver link reliability. For release 18, 3GPP is looking to evolve the wireless technology and expand its operation into unlicensed frequency spectrum for bigger bandwidth, faster data rate, and easier market adoption of D2D communication using sidelink without requiring mobile cellular operators to configure and allocate a part of their expansive mobile radio spectrum for data services that do not go throughput their mobile networks.

### SUMMARY

In some embodiments, a resource selection method for back-to-back transmissions in sidelink communication (SL) by a user equipment (UE) includes triggering, by a higher layer of the UE, a first layer of the UE to perform a resource selection procedure based on one or more of parameters provided by the higher layer to report a remaining set of candidate resources, wherein the remaining set of candidate resources includes at least one set of resources in contiguous time slots.

In some embodiments, a user equipment (UE) includes a memory, a transceiver, and a processor coupled to the memory and the transceiver. The UE is configured to perform: triggering, by a higher layer of the UE, a first layer of the UE to perform a resource selection procedure based on one or more of parameters provided by the higher layer to report a remaining set of candidate resources, wherein the remaining set of candidate resources includes at least one set of resources in contiguous time slots.

In some embodiments, a chip includes a processor, configured to call and run a computer program stored in a memory, to cause a device in which the chip is installed to execute: triggering, by a higher layer of the device, a first layer of the device to perform a resource selection procedure based on one or more of parameters provided by the higher layer to report a remaining set of candidate resources, wherein the remaining set of candidate resources includes at least one set of resources in contiguous time slots.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a resource selection method for back-to-back transmissions in sidelink communication (SL) by a UE according to an embodiment of the present disclosure.

FIG. 5 is a schematic diagram illustrating an exemplary proposed resource selection method for multi-consecutive slots transmission (MCSt) in SL communication according to an embodiment of the present disclosure.

FIG. 6 is a schematic diagram illustrating an exemplary proposed resource selection method for MCSt when a sidelink hybrid automatic repeat request (SL-HARQ) feedback is enabled according to an embodiment of the present disclosure.

FIG. 7 is a flowchart illustrating a resource selection method for back-to-back transmissions in SL by a UE according to an embodiment of the present disclosure.

FIG. 8 is a block diagram of a UE for wireless communication according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Unlicensed Spectrum

Traditionally, unlicensed (also referred as license-exempted) radio spectrum in 2.4 GHz and 5 GHz bands are commonly used by Wi-Fi and Bluetooth wireless technologies for short range communication (such as from just a few meters to few tens of meters). It is often claimed that more traffic is carried over unlicensed spectrum bands than any other radio bands since the frequency spectrum is free/at no-cost to use by anyone as long as communication devices are compliant to certain local technical regulations. Besides, Wi-Fi, Bluetooth, and other radio access technologies (RATs) such as licensed-assisted access (LAA) based on 4G-long term evolution (LTE) and new radio unlicensed (NR-U) based on 5G-new radio (NR) mobile systems from 3GPP also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting on the same channel.

For the sidelink wireless technology to also operate and coexistence with existing RATs already operating in the unlicensed bands, LBT based schemes can be employed to make certain there is no on-going activity on the radio channel before attempting to access the channel for transmission. For example, when a type 1 LBT is successfully performed by a sidelink user equipment (UE), the UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 25 us. Hence, potentially losing the access to the channel until another successful LBT is performed. A potential solution to this issue of losing the access to the channel could be a back-to-back (B2B) transmission.

### Back-to-Back Transmission

The main purpose of B2B transmission (which can be also referred as “burst transmission” or “multi-consecutive slot transmission (MCSt)”) is intended for a sidelink (SL) communicating UE to occupy an unlicensed channel continuously for longer duration of time (i.e., more than one time slot) without a risk of losing the access to the channel to wireless transmission (Tx) devices of other radio access technologies (RATs). This can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or has a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 4, 8, or 10 ms), the intention is to retain the channel access for as long as possible (e.g., all or most of the COT length) to send as much data as possible by continuously transmitting in the unlicensed channel such that wireless devices of other RATs would not have a chance to access the channel.

### Multiple Starting Symbols (in a Time Slot for SL Transmission)

As described earlier, a UE needs to firstly perform a type 1 LBT channel access procedure on an unlicensed channel to acquire a COT before the is allowed to transmit any SL signal(s) or channel(s) over the channel. Depending on the random selection outcome of a backoff counter for the channel sensing, the required time duration to perform the type 1 LBT is unpredictable. As such, the UE typically needs to perform the type 1 LBT process in advanced of a scheduled transmission with a time margin to account for the randomness of the counter. According to the existing SL frame structure, the UE performs SL data and the associated control channel transmissions at the slot boundary, and each data plus control transmission length is one slot. This implies the end/finishing time of the type 1 LBT can ideally finish just before the boundary of the scheduled slot for transmission. But this may not always happen due to unpredictable random selection outcome and also the count down process is on hold when other devices are accessing the channel. To counter this effect and thus allowing more opportunities for the UE to access the channel, the UE may be allowed to start SL transmissions from a different position/location/symbol within a slot (e.g., in the middle of a slot, symbol 7 in a slot with 14 symbols).

### Mode 2 Resource Selection in Sidelink

In the existing design of resource allocation mechanism for SL communication, a mode 2 resource selection method relies on the SL transmission UE to perform autonomous selection of resources from a SL resource pool for its own transmission of data messages. In this exemplary method, the selection of transmission resources is not random but based on a sensing and reservation strategy to avoid collision with other SL transmission UEs operating in the same resource pool. In this exemplary resource selection strategy, a transmission UE senses the channel within a sensing window (which is different from the LBT channel sensing) to detect and decode SL resource reservation information from other transmission UEs. Based on the resource reservation information, the UE excludes some of the reserved resources from selection to avoid transmission collision. Likewise, the UE also sends out/broadcasts its own resource reservation information in the resource pool when it transmits data and control messages, so that other UEs may avoid selecting the same resource. In the existing resource selection and reservation signaling design, the time gap between two consecutive resources can be up to 31 slots apart. With this type of resource selection method, it is not ideal for MCSt as there is no guarantee that resources may be selected contiguously in time.

There is a need for a user equipment (UE) and resource selection method for back-to-back transmissions in sidelink communication (SL), which can solve issues in the prior art, avoid transmission collision, ensure that an access to an unlicensed wireless channel is retained for its own transmissions, provide a good communication performance, and/or provide high reliability.

In the exemplary present proposed resource selection method for sidelink communication, the main objective is to guarantee there is at least one set of available/candidate resources that are contiguous in time for multi-consecutive slots transmission (MCSt) and non-colliding with other reservations and transmissions. Thus, ensuring the access to the unlicensed wireless channel is retained for its own transmissions. Other benefits from adopting the proposed exemplary resource selection method for MCSt may include one or more of the followings: 1. Allow sharing of COT information and coordination with other UEs to fully utilize the COT. 2. It can be easily adapted to transmit packet data unit (MAC PDU) or data transport block (TB) that requires SL-HARQ feedback.

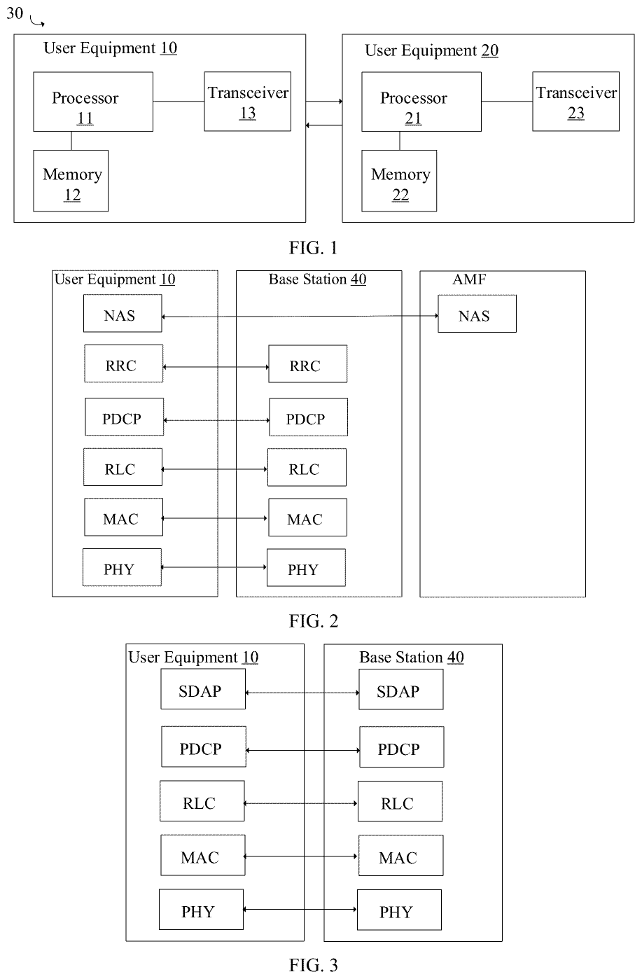

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the higher layer of the UE 10 is configured to trigger the first layer of the UE 10 to perform a resource selection procedure based on one or more of parameters provided by the higher layer to report a remaining set of candidate resources, wherein the remaining set of candidate resources includes at least one set of resources in contiguous time slots. In some examples, the first layer refers to layer 1 (L1)/PHY layer. In some examples, the higher layer refers to MAC layer. This can solve issues in the prior art, avoid transmission collision, ensure that an access to an unlicensed wireless channel is retained for its own transmissions, provide a good communication performance, and/or provide high reliability.

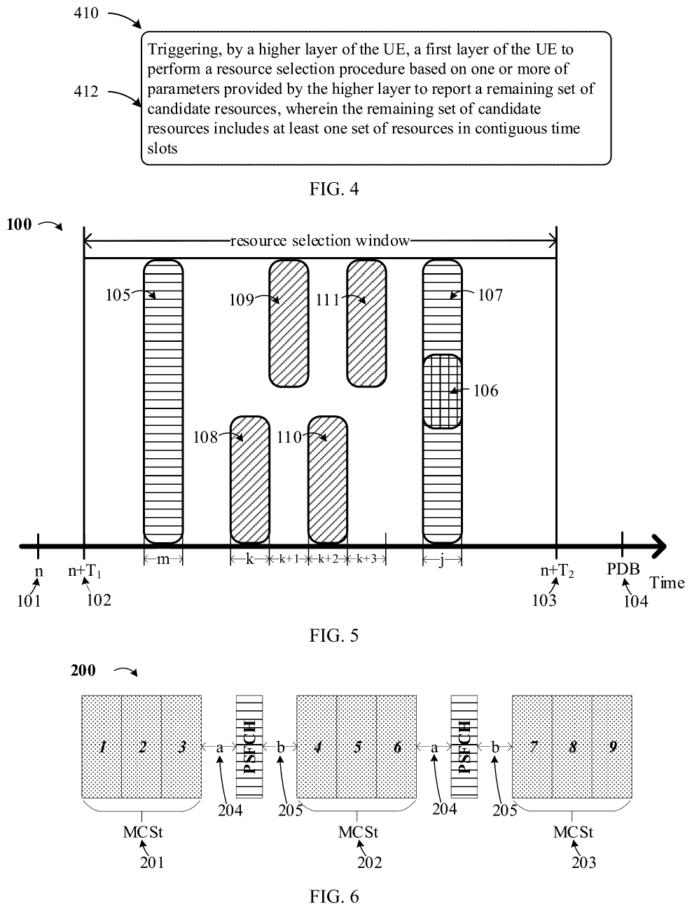

FIG. 4 illustrates a resource selection method 410 for back-to-back transmissions in sidelink communication (SL) by a UE according to an embodiment of the present disclosure. In some embodiments, the method 410 includes: a block 412, triggering, by a higher layer of the UE, a first layer of the UE to perform a resource selection procedure based on one or more of parameters provided by the higher layer to report a remaining set of candidate resources, wherein the remaining set of candidate resources includes at least one set of resources in contiguous time slots. In some examples, the first layer refers to layer 1 (L1)/PHY layer. In some examples, the higher layer refers to MAC layer. This can solve issues in the prior art, avoid transmission collision, ensure that an access to an unlicensed wireless channel is retained for its own transmissions, provide a good communication performance, and/or provide high reliability.

In some embodiments, the one or more of parameters provided by the higher layer includes: a channel access priority class (CAPC) level, a time length of multi-consecutive slots transmission (MCSt) or number of contiguous time slots, MCSt selection enabled/disabled, SL-hybrid automatic repeat request (HARQ) feedback enabled/disabled, a L1 priority of a physical sidelink shared channel (PSSCH) and its associated PSCCH transmission, a number of SL resource sub-channels, and/or a packet delay budget (PDB) or a remaining PDB. In some embodiments, reporting, by the first layer to the higher layer, the remaining set of candidate resources includes performing, by the first layer, SL sensing, initializing, by the first layer, a candidate resource set, and excluding, by the first layer, resources from the candidate resource set based on the one or more of parameters provided by the higher layer.

In some embodiments, the resource selection procedure performed by the first layer includes a first stage of a resource exclusion process, wherein the first stage of the resource exclusion process includes excluding, by the first layer, resources at a per-slot level basis from the remaining set of candidate resources according to one or more of the following conditions: UE's own SL PSSCH/physical sidelink control channel (PSCCH) and/or uplink (UL) transmissions, sidelink synchronization signal block (S-SSB) transmission and/or reception occasions/slots, slots configured with PSFCH resources, and/or time for performing a type 1 channel access procedure.

In some embodiments, the resource selection procedure performed by the first layer further includes a second stage of the resource exclusion process. The second stage of the resource exclusion process includes excluding, by the first layer, resources at a per-resource level basis from the remaining set of candidate resources based on resource reservation information and a priority received in an sidelink control information (SCI), and a measured reference signal received power (RSRP). In some embodiments, in the second stage of the resource exclusion process, if a number of set of contiguous candidate resources remained after the per-resource level basis resource exclusion process does not satisfy one or more of the following criteria, a RSRP threshold level is increased and the first stage and the second stage of the resource exclusion process are repeated. In some embodiments, the RSRP threshold level is increased until one or more of the following criteria is satisfied: there is at least one set of contiguous candidate resources remaining in the remaining set of candidate resources, there are at least Y sets of contiguous candidate resources remaining in the remaining set of candidate resources, and/or a number of sets of contiguous candidate resources remaining in the remaining set of candidate resources is at least X % of a total number of sets of contiguous candidate resources. In some embodiments, a value of Y and/or a value of X % are pre-configured, pre-defined, and/or provided by the higher layer.

In some embodiments, the method further including selecting, by the higher layer, MCSt resources from the remaining set of candidate resources for PSSCH/PSCCH transmissions. In some embodiments, when there are more than one set of contiguous candidate resources reported to the higher layer, the higher layer performs selection among the sets of contiguous candidate resources according one or more of the following criteria: not overlap with slots of own SL and/or UL transmissions, not overlap with an additional/extra time required to complete the type 1 channel access procedure, prioritizing earlier in time or an earliest set of resources that are in contiguous time slots, prioritizing selection of set of contiguous time slot resources that are right before or after a resource reserved by another UE, and/or a required time gap between multiple/adjacent transmissions of MCSt when a SL-HARQ feedback is enabled or a SL-HARQ feedback is associated with a logical channel of a medium access control packet data unit (MAC PDU)/transport block (TB).

In the present disclosure of inventive exemplary method of resource selection for multi-consecutive slots transmission (MCSt) in sidelink (SL) communication, the exemplary method provides an efficient way of selecting resources for a UE operating in SL resource allocation mode 2 that guarantees there are at least one set of candidate resources contiguous in time slots for transmitting one or more medium access control packet data units (MAC PDUs)/transport blocks (TBs) in a physical sidelink shared channel (PSSCH) and the associated physical sidelink control channel (PSCCH). By ensuring that the SL transmission is contiguous in time slots (i.e., leaving no empty/gap slot between the contiguous time slots), it helps to retain the access to the radio channel from being taken over by a device of another radio access technology (RAT), such as Wi-Fi, NR-U, or LAA, when the SL is operating in an unlicensed spectrum. In addition, by UE performing a SL sensing of possible reservation of resources from other SL UEs, it avoids collision with other SL transmissions in the same channel and resource pool by excluding the reserved resources from a set of candidate resources for selection. The proposed exemplary resource selection method also excludes resources in slots where the TX UE has its own transmissions, such as sidelink synchronization signal block (S-SSB), physical sidelink feedback channel (PSFCH), other PSSCH/PSCCH, and/or uplink (UL) transmissions, to endure the remaining candidate resources are not interrupted/separated by other signals or channels.

Furthermore, the proposed exemplary resource selection method takes into account of the timing requirement in SL hybrid automatic repeat request (SL-HARQ) feedback by ensuring that sufficient time gap(s) are provided between multiple MCSt transmissions. Lastly, the proposed exemplary resource selection method is also compatible with the operation of multiple starting symbols within a slot and channel occupancy time (COT) sharing, which are new features introduced to enable and enhance SL operation in the unlicensed spectrum.

In the following, detailed description of the proposed resource selection method for MCSt in SL communication is provided.

### Resource (Re)selection Procedure in L1/PHY Layer

In order to ensure that there is at least one set of candidate resources that are contiguous in time slots for MCSt and the selection of resources may avoid collision with transmissions from other UE(s) in the same resource pool, the proposed exemplary resource (re)selection method includes the UE higher layer triggering the L1/PHY layer to start a resource selection procedure to report a set of available candidate resources from which the higher layer may select MCSt resources for PSSCH/PSCCH transmissions of one or more MAC PDUs or TBs.

To trigger the resource selection procedure in the L1/PHY layer, in slot n, the higher layer provides at least one or more of the following parameters.

Channel access priority class (CAPC) level (p) for the PSSCH and its associated PSCCH transmission. This information can be used by the UE L1/PHY layer for determining the length of MCSt and/or number of additional slots of resources that can be excluded from a candidate resource set.

Length of MCSt/number of contiguous time slots (e.g., 2, 3, 4, . . . , 40 slots). This parameter is to indicate a minimum number of contiguous time slots in reporting one or more sets of candidate resources for MCSt.

MCSt selection enabled/disabled. As an alternative to the above higher layer parameter “length of MCSt/number of contiguous time slots”, the UE L1/PHY layer could derive/determine this information based on the SL CAPC (p). For example, when p=1, 2, 3, and 4, the length of MCSt/number of slots contiguous in time could be 2, 4, 6, or 10 for 15 kHz sub-carrier spacing (SCS). When p=1, 2, 3, and 4, the length of MCSt/number of slots contiguous in time could be 4, 8, 12, or 20 for 30 kHz sub-carrier spacing (SCS). When p=1, 2, 3, and 4, the length of MCSt/number of slots contiguous in time could be 8, 16, 24, or 40 for 60 kHz sub-carrier spacing (SCS). As another approach, a Z % percentage of the maximum COT duration (T_{slm cot, p}) for a given SL CAPC (p) could be (pre-)configured, pre-defined, or provided by the higher layer. For example, if Z=50 and SCS is 15 kHz, this means the length of MCSt/number of slots contiguous could be determined to be 3 slots for a SL CAPC p=3. For another example, if Z=50 and SCS is 30 kHz, this means the length of MCSt/number of slots contiguous could be determined to be 4 slots for a SL CAPC p=2.

SL-HARQ feedback enabled/disabled. This information can be useful in ensuring that there are sufficient gap(s) between two MCSt transmissions.

L1 priority of the PSSCH and its associated PSCCH transmission. This is needed during the resource exclusion stage/step in determine whether a reserved resource from another UE can be excluded or not from a candidate resource set by comparing a RSRP threshold level associated with this L1 priority for transmission and the L1 priority of the reserved resource.

Number of SL resource sub-channels. This information is for determining the size of a candidate resource that can be reported to the higher layer.

Packet delay budget (PDB) or the remaining PDB. This information is needed for determining the maximum time length or the end point/finish time for a selection window.

In the above mentioned embodiments, in order to avoid transmission collision with other SL UEs operating in the same resource pool, the UE can perform blind decoding of sidelink control information (SCI) transmitted in PSCCH within a sensing window to obtain reservation information of future resources from other UEs. In addition, the UE can measure sidelink RSRP level of the decoded SCI for determining whether the associated resource reserved in the SCI needs to be excluded from a candidate resource set during the resource exclusion process/step.

Based on the above information provided by the higher layer, the next step is to determine/initialize a set of all possible candidate resources within a resource selection window. FIG. 5 illustrates an exemplary proposed resource selection method for multi-consecutive slots transmission (MCSt) in SL communication according to an embodiment of the present disclosure. Let's denote the set as S_{A} and define the resource selection window as [n+T₁, n+T₂] as illustrated in diagram 100 of FIGS. 5 as 102 and 103, where the resource selection procedure is triggered in slot n 101 and the resources can be selected before the end of the PDB 104. T₁ is selected based the sub-carrier spacing (SCS) of the SL bandwidth part on to account for the time required to encode PSSCH/PSCCH before transmission. The higher the SCS for the SL bandwidth part, the larger the number of slots for T₁. Then, the set S_{A} is initialized to all the possible candidate resources within the resource selection window, each with a size according to the “number of SL resource sub-channels” parameter provided by the higher layer.

For the resource exclusion process, it can be divided into 2 stages, a first stage for excluding candidate resources at a slot level granularity (i.e., for the entire slot) according to one or more conditions and a second stage for excluding candidate resource within a slot at a resource level granularity based on resource reservation from other UEs.

### First Stage of the Resource Exclusion Process (Per-Slot Level Exclusion)

During the first stage of the resource exclusion process, the intention is to exclude an entire slot of candidate resources due to infeasibility for the UE to utilize these slots. Some of the infeasibility issues could include one or more of the following areas.

Half-duplex issue due to own SL PSSCH/PSCCH and/or UL transmissions. When the UE is triggered to select resources for MCSt, the UE may have already previously selected some SL resources for transmitting other MAC PDUs or TBs. If one of these resources pre-selected or reserved falls/is located in the resource selection window for the MCSt, the resources within the entire slot can be excluded from the candidate resource set S_{A} since the UE is not expected to perform simultaneous transmission for two or more SL MAC PDUs/TBs in the same slot. Similarly, if the UE has any uplink (UL) transmission that falls within the resource selection window or overlaps with the time duration of the candidate resource set S_{A}, candidate resources in the overlapped slots can be excluded from the candidate resource set S_{A}. This is exemplarily illustrated in diagram 100 of FIG. 5, where the UE has a scheduled UL transmission in slot m and a pre-selected/reserved resource 106 in slot j, the UE can exclude the entire slot of resources 105 and 107 in slot m and slot j from the candidate resource set S_{A}, respectively since these slots are unusable for the MCSt.

S-SSB occasions/slots (including both TX and RX occasions/slots). Due to the above same half-duplex and simultaneous transmission issues, S-SSB slots for both transmission and reception that fall/are located within the resource selection window and/or overlap with the candidate resource set S_{A} can be excluded as well.

Slots (pre-)configured with PSFCH resources. In the existing SL frame structure, when PSFCH resources are (pre-)configured in a resource pool, symbol index 11, 12, and 13 in a slot with 14 symbols are set aside for PSFCH transmission. Since these symbols cannot be used for PSSCH, they become a big transmission gap in the MCSt and potentially cause the UE to loss the access to the unlicensed channel if no other UE also transmit PSFCH in these symbols. Therefore, SL slots with PSFCH resources (pre-)configured in the resource pool can be excluded from the candidate resource set S_{A}.

Processing time for type 1 channel access procedure. This is the additional time required to perform type 1 channel access procedure at the UE in order to access the shared channel. This processing time could include at least the maximum contention window size for the corresponding SL CAPC level (CW_{max, p}). For example, in 15 kHz SCS, the maximum allowable processing time T₁ for encoding PSSCH/PSCCH before transmission is 3 slots (3 ms). If the provided SL CAPC level for a PSSCH/PSCCH transmission is p=3 or p=4, the maximum contention window size for type 1 channel access procedure would be around 9.2 ms. Assuming the T₁ processing time can be also used for the type 1 channel sensing, the first 6 to 7 slots of candidate resources (after n+T₁) of the resource selection window can be also excluded from the set S_{A}. Alternatively, this processing time for type 1 channel sensing can be handled/excluded by the higher layer (i.e., MAC layer) during the final resource selection.

### Second Stage of the Resource Exclusion Process (Per-Resource Level Exclusion)

During the second stage of the resource exclusion process, the intention is to exclude resources that overlap with other UE's reserved resources (i.e., indicated in the received SCI) from the candidate resource set S_{A} to avoid transmission collisions. To do this, the UE compares the measured RSRP of a reserved resource against a RSRP threshold according to the priority level of the reserved resource and the priority level of the intended SL transmission. If the measure RSRP of the reserved resource is higher than the RSRP threshold, all candidate resources that overlap with the reserved resource are excluded from the candidate resource set S_{A}.

However, after the exclusion of overlapping resources from the candidate resource set S_{A}, the remaining candidate resources in the candidate resource set S_{A} may not be sufficient or usable for MCSt. For example, the remaining available candidate resources are not contiguous in time slots and scattered across the resource pool. In order to ensure that the remaining candidate resource set S_{A} to be reported to the higher layer is usable for MCSt, after an initial exclusion of indicated/reserved resources from the candidate resource set (S_{A}), if there are no set of contiguous candidate resources remained in the candidate resource set S_{A}, the RSRP threshold level is increased (e.g., by 3 dB) until at least one of the following criteria is satisfied.

There is at least one set of contiguous candidate resources remaining in the candidate resource set S_{A} (i.e., resource selection window). In reference to diagram 100 of FIG. 5, the remaining candidate resources 108, 109, 110, and 111 in contiguous time slots k, k+1, k+2 and k+3, respectively, constitute a set of contiguous candidate resources that can be used for MCSt when the required length of MCSt is 4. Note that, the frequency position/location of the remaining candidate resource in each slot (i.e., the sub-channel index) does not need to be the same for MCSt in order to retain the access to the unlicensed channel.

There are at least Y sets of contiguous candidate resources remaining in the candidate resource set S_{A}.

Number of sets of contiguous candidate resources remaining in the candidate resource set S_{A} is at least X % of the total number of sets of contiguous candidate resources.

The value of Y and X % could be (pre-)configured, pre-defined, and/or provided by the higher layer of the UE. The UE then reports the remaining candidate resource set in the candidate resource S_{A}, which is a subset of the initialized candidate resources before the resource exclusion process, to the higher layer for the final selection of resources for MCSt.

### Resource (Re)selection Procedure in Higher Layer (MAC Layer)

Once the remaining candidate resource set S_{A} is reported by the UE L1/PHY layer, the UE MAC layer performs the final selection of resources that are contiguous in time slots for MCSt. As described earlier, the UE L1/PHY layer may report only one set or more than one set of contiguous candidate resources in the candidate resource set S_{A}. In the case when there is only one set is reported, the MAC layer selects the only set of contiguous time slot resources that satisfy the required length for MCSt.

For the case when more than one set of contiguous candidate resources are reported, the UE MAC layer may perform selection among the sets according one or more of the following criteria to further enhance the performance of SL communication.

Exclusion of slots due to own SL (e.g., PSSCH/PSCCH, S-SSB, PSFCH) and/or UL transmissions if not already done at L1/PHY layer. As described earlier, resources within the slots of other SL and/or UL transmissions from the UE can be also excluded from selection. If this exclusion is not done at the UE L1/PHY layer, these slots can be excluded/taken into consideration during the final selection of resources in the MAC layer.

As also described earlier, the time required to perform type 1 channel access procedure may take longer than the T₁ time to encode PSSCH/PSCCH for transmission, especially for CAPC level p=3 and p=4. As such, this additional/extra time required to complete the type 1 channel access procedure can be taken into account by excluding/not selecting resources in the MAC layer in slots that could potentially located within the extra time (e.g., the first few slots of the reported candidate resource set S_{A}), if this has not already been done by the L1/PHY layer during the resource exclusion step.

Prioritize earlier in time or the earliest set of resources that are contiguous in time slots during the final selection of resources in the MAC layer. Firstly, by transmitting MAC PDU/TB earlier in time, it helps to reduce the latency in delivering data information to the receiver UE and hence improve the overall performance and user experience. Secondly, since there is no guarantee that any LBT channel access procedure may be successful every time, if the UE experience LBT failure in attempting to access the unlicensed channel earlier in time, there is more opportunity for the UE to perform re-selection of resources within the remaining PDB.

Prioritize selection of set of contiguous time slot resources that are right before or after a resource reserved by a different UE to whom the TX-UE intends to share its COT with. For example, in a unicast communication between only two SL UEs, it is beneficial for either one of the UEs to select resources just before the other UE's reserved resource/planned transmission such that the COT initiated by the earlier transmission UE could be shared with the latter UE to improve the success of the channel access. Additionally, this may also help with the half-duplex issue that are common in a unicast communication where the two UEs cannot receive each other's data messages when both are transmitting at the same time. By selecting resources right after the other UE's transmission, it creates the opportunity for the TX-UE to enjoy the COT shared from the other/earlier UE.

Ensure sufficient time gap between the multiple/adjacent transmissions of MCSt when SL-HARQ feedback is enabled or SL-HARQ feedback is associated with the logical channel of the MAC PDU/TB. When multiple sets of contiguous candidate resources are reported in the candidate resource set SA and the MAC PDU/TB is associated with SL-HARQ feedback (i.e., SL-HARQ feedback is enabled and the receiver UE is required to provide SL-HARQ feedback in PSFCH), the MAC layer may be able to select more than one set of contiguous time slot resources for multiple MCSt transmissions for the same MAC PDU/TB. In this case, the UE MAC layer may ensure that there is sufficient time gap between the multiple MCSt transmission instances to allow for SL-HARQ feedback in PSFCH.

FIG. 6 illustrates an exemplary proposed resource selection method for MCSt when a sidelink hybrid automatic repeat request (SL-HARQ) feedback is enabled according to an embodiment of the present disclosure. As an exemplary illustrated in diagram 200 of FIG. 6, when multiple sets of MCSt resources 201, 202, 203 are selected, the UE MAC layer may ensure that there is a minimum time gap of at least ‘a’ number of slots (204s) from the end of a MCSt to the corresponding PSFCH occasion for the SL-HARQ feedback and/or there is a minimum time gap of at least ‘b’ number of slots (205s) between the SL-HARQ feedback PSFCH occasion and the start of the following MCSt. The minimum time gap of ‘a’ number of slots is for the receiver UE to decode PSSCH/PSCCH and prepare SL-HARQ feedback information. The minimum time gap of ‘b’ number of slots is for the TX-UE to encode and prepare PSSCH/PSCCH for MCSt in the event of a NACK is received in PSFCH.

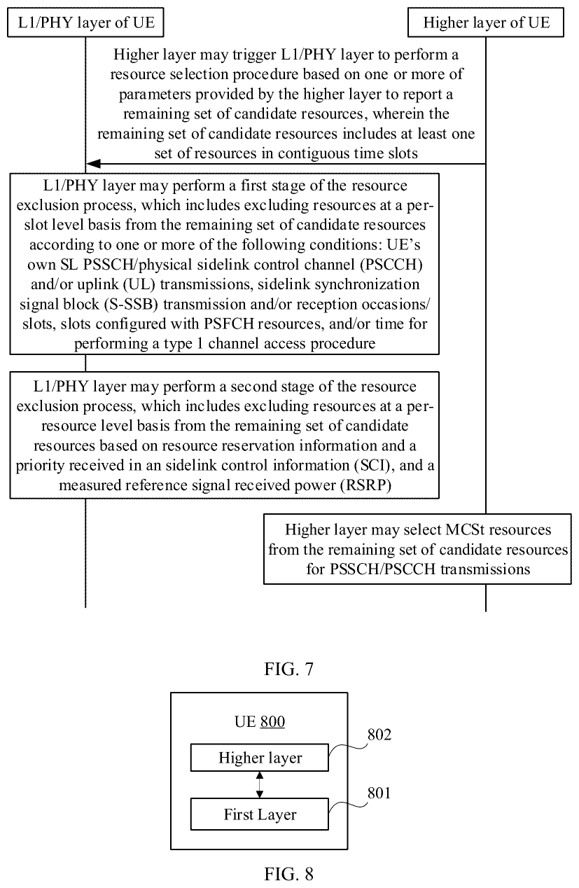

FIG. 7 illustrates a resource selection method for back-to-back transmissions in SL by a UE according to an embodiment of the present disclosure. In some embodiments, the method includes: a step of triggering, by a higher layer of the UE, a first layer of the UE to perform a resource selection procedure based on one or more of parameters provided by the higher layer to report a remaining set of candidate resources, wherein the remaining set of candidate resources includes at least one set of resources in contiguous time slots, a step of a first stage of a resource exclusion process, wherein the first stage of the resource exclusion process includes excluding, by the first layer, resources at a per-slot level basis from the remaining set of candidate resources according to one or more of the following conditions: UE's own SL PSSCH/physical sidelink control channel (PSCCH) and/or uplink (UL) transmissions, sidelink synchronization signal block (S-SSB) transmission and/or reception occasions/slots, slots configured with PSFCH resources, and/or time for performing a type 1 channel access procedure, a step of a second stage of the resource exclusion process, wherein the second stage of the resource exclusion process includes excluding, by the first layer, resources at a per-resource level basis from the remaining set of candidate resources based on resource reservation information and a priority received in an sidelink control information (SCI), and a measured reference signal received power (RSRP), and a step of selecting, by the higher layer, MCSt resources from the remaining set of candidate resources for PSSCH/PSCCH transmissions. In some embodiments, when there are more than one set of contiguous candidate resources reported to the higher layer, the higher layer performs selection among the sets of contiguous candidate resources according one or more of the following criteria: not overlap with slots of own SL and/or UL transmissions, not overlap with an additional/extra time required to complete the type 1 channel access procedure, prioritizing earlier in time or an earliest set of resources that are in contiguous time slots, prioritizing selection of set of contiguous time slot resources that are right before or after a resource reserved by another UE, and/or a required time gap between multiple/adjacent transmissions of MCSt when a SL-HARQ feedback is enabled or a SL-HARQ feedback is associated with a logical channel of a medium access control packet data unit (MAC PDU)/transport block (TB). In some examples, the first layer refers to layer 1 (L1)/PHY layer of a UE. In some examples, the higher layer refers to MAC layer. This can solve issues in the prior art, avoid transmission collision, ensure that an access to an unlicensed wireless channel is retained for its own transmissions, provide a good communication performance, and/or provide high reliability.

FIG. 8 illustrates a UE 800 for wireless communication according to an embodiment of the present disclosure. The UE 800 includes a first layer 801 and a higher layer 802 coupled to the first layer. The higher layer 802 is configured to trigger the first layer 801 to perform a resource selection procedure based on one or more of parameters provided by the higher layer 802 to report a remaining set of candidate resources, wherein the remaining set of candidate resources includes at least one set of resources in contiguous time slots. In some examples, the first layer 801 refers to L1/PHY layer. In some examples, the higher layer 802 refers to MAC layer. The UE 800 is configured to perform the above method in the above embodiments. This can solve issues in the prior art, avoid transmission collision, ensure that an access to an unlicensed wireless channel is retained for its own transmissions, provide a good communication performance, and/or provide high reliability.

Commercial interests for some embodiments are as follows. 1. Solving issues in the prior art. 2. Avoiding transmission collision. 3. Ensuring that an access to an unlicensed wireless channel is retained for its own transmissions. 4. Providing good communication performance. 5. Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

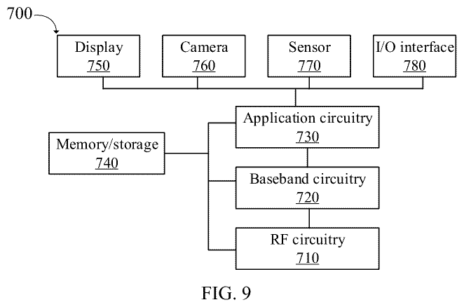

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A resource selection method for back-to-back transmissions in sidelink communication (SL) by a user equipment (UE), comprising:
triggering, by a higher layer of the UE, a first layer of the UE to perform a resource selection procedure based on one or more of parameters provided by the higher layer to report a remaining set of candidate resources, wherein the remaining set of candidate resources comprises at least one set of resources in contiguous time slots.

2. The method of claim 1, wherein the one or more of parameters provided by the higher layer comprises at least one of:
a channel access priority class (CAPC) level;
a time length of multi-consecutive slots transmission (MCSt) or number of contiguous time slots;
MCSt selection enabled/disabled;
SL-hybrid automatic repeat request (HARQ) feedback enabled/disabled;
a L1 priority of a physical sidelink shared channel (PSSCH) and its associated PSCCH transmission;
a number of SL resource sub-channels; or
a packet delay budget (PDB) or a remaining PDB.

3. The method of claim 1, wherein reporting, by the first layer to the higher layer, the remaining set of candidate resources comprises performing, by the first layer, SL sensing, initializing, by the first layer, a candidate resource set, and excluding, by the first layer, resources from the candidate resource set based on the one or more of parameters provided by the higher layer.

4. The method of claim 1, wherein the resource selection procedure performed by the first layer comprises a first stage of a resource exclusion process, wherein the first stage of the resource exclusion process comprises excluding, by the first layer, resources at a per-slot level basis from the remaining set of candidate resources according to one or more of the following conditions:
UE's own SL PSSCH/physical sidelink control channel (PSCCH) and/or uplink (UL) transmissions;
sidelink synchronization signal block (S-SSB) transmission and/or reception occasions/slots;
slots configured with PSFCH resources; or
time for performing a type 1 channel access procedure.

5. The method of claim 4, wherein the resource selection procedure performed by the first layer further comprises a second stage of the resource exclusion process, wherein the second stage of the resource exclusion process comprises excluding, by the first layer, resources at a per-resource level basis from the remaining set of candidate resources based on resource reservation information and a priority received in an sidelink control information (SCI), and a measured reference signal received power (RSRP).

6. The method of claim 5, wherein in the second stage of the resource exclusion process, if a number of set of contiguous candidate resources remained after the per-resource level basis resource exclusion process does not satisfy one or more of the following criteria, a RSRP threshold level is increased and the first stage and the second stage of the resource exclusion process are repeated.

7. The method of claim 6, wherein the RSRP threshold level is increased until one or more of the following criteria is satisfied:
wherein there is at least one set of contiguous candidate resources remaining in the remaining set of candidate resources;
wherein there are at least Y sets of contiguous candidate resources remaining in the remaining set of candidate resources; or
wherein a number of sets of contiguous candidate resources remaining in the remaining set of candidate resources is at least X % of a total number of sets of contiguous candidate resources.

8. The method of claim 7, wherein a value of Y and/or a value of X % are pre-configured, pre-defined, and/or provided by the higher layer.

9. The method of claim 1, further comprising selecting, by the higher layer, MCSt resources from the remaining set of candidate resources for PSSCH/PSCCH transmissions.

10. The method of claim 9, wherein when there are more than one set of contiguous candidate resources reported to the higher layer, the higher layer performs selection among the sets of contiguous candidate resources according one or more of the following criteria:
not overlap with slots of own SL and/or UL transmissions;
not overlap with an additional/extra time required to complete the type 1 channel access procedure;
prioritizing earlier in time or an earliest set of resources that are in contiguous time slots;
prioritizing selection of set of contiguous time slot resources that are right before or after a resource reserved by another UE; or
a required time gap between multiple/adjacent transmissions of MCSt when a SL-HARQ feedback is enabled or a SL-HARQ feedback is associated with a logical channel of a medium access control packet data unit (MAC PDU)/transport block (TB).

11. A user equipment (UE), comprising:
a memory;
a transceiver; and
a processor coupled to the memory and the transceiver;
wherein the UE is configured to perform:
triggering, by a higher layer of the UE, a first layer of the UE to perform a resource selection procedure based on one or more of parameters provided by the higher layer to report a remaining set of candidate resources, wherein the remaining set of candidate resources comprises at least one set of resources in contiguous time slots.

12. The UE of claim 11, wherein the one or more of parameters provided by the higher layer comprises at least one of:
a channel access priority class (CAPC) level;
a time length of multi-consecutive slots transmission (MCSt) or number of contiguous time slots;
MCSt selection enabled/disabled;
SL-hybrid automatic repeat request (HARQ) feedback enabled/disabled;
a L1 priority of a physical sidelink shared channel (PSSCH) and its associated PSCCH transmission;
a number of SL resource sub-channels; or
a packet delay budget (PDB) or a remaining PDB.

13. The UE of claim 11, wherein the UE is configured to perform:
performing, by the first layer, SL sensing, initializing, by the first layer, a candidate resource set, and excluding, by the first layer, resources from the candidate resource set based on the one or more of parameters provided by the higher layer.

14. The UE of claim 11, wherein the resource selection procedure performed by the first layer comprises a first stage of a resource exclusion process, wherein the first stage of the resource exclusion process comprises excluding, by the first layer, resources at a per-slot level basis from the remaining set of candidate resources according to one or more of the following conditions:
UE's own SL PSSCH/physical sidelink control channel (PSCCH) and/or uplink (UL) transmissions;
sidelink synchronization signal block (S-SSB) transmission and/or reception occasions/slots;
slots configured with PSFCH resources; and/or
time for performing a type 1 channel access procedure.

15. The UE of claim 14, wherein the resource selection procedure performed by the first layer further comprises a second stage of the resource exclusion process, wherein the second stage of the resource exclusion process comprises excluding, by the first layer, resources at a per-resource level basis from the remaining set of candidate resources based on resource reservation information and a priority received in an sidelink control information (SCI), and a measured reference signal received power (RSRP).

16. The UE of claim 15, wherein in the second stage of the resource exclusion process, if a number of set of contiguous candidate resources remained after the per-resource level basis resource exclusion process does not satisfy one or more of the following criteria, a RSRP threshold level is increased and the first stage and the second stage of the resource exclusion process are repeated.

17. The UE of claim 16, wherein the RSRP threshold level is increased until one or more of the following criteria is satisfied:
wherein there is at least one set of contiguous candidate resources remaining in the remaining set of candidate resources;
wherein there are at least Y sets of contiguous candidate resources remaining in the remaining set of candidate resources; or
wherein a number of sets of contiguous candidate resources remaining in the remaining set of candidate resources is at least X % of a total number of sets of contiguous candidate resources.

18. The UE of claim 17, wherein a value of Y and/or a value of X % are pre-configured, pre-defined, and/or provided by the higher layer.

19. The UE of claim 11, wherein the UE is configured to further perform:
selecting, by the higher layer, MCSt resources from the remaining set of candidate resources for PSSCH/PSCCH transmissions.

20. A chip, comprising:
a processor configured to execute a computer program stored in a memory, to cause a device in which the chip is installed to:
trigger, by a higher layer of the device, a first layer of the device to perform a resource selection procedure based on one or more of parameters provided by the higher layer to report a remaining set of candidate resources, wherein the remaining set of candidate resources comprises at least one set of resources in contiguous time slots.
